(19) United States
(12) Patent Application Publication
(10) Pub. No.: US 2025/0166251 A1
(43) Pub. Date: May 22, 2025

(54) METHODS AND SYSTEMS FOR CORRECTING METAL ARTIFACTS

(71) Applicant: SHANGHAI UNITED IMAGING HEALTHCARE CO., LTD., Shanghai (CN)

(72) Inventor: Zhonghua SHI, Shanghai (CN)

(73) Assignee: SHANGHAI UNITED IMAGING HEALTHCARE CO., LTD., Shanghai (CN)

(21) Appl. No.: 19/031,407

(22) Filed: Jan. 18, 2025

Related U.S. Application Data
(63) Continuation of application No. PCT/CN2022/133002, filed on Nov. 18, 2022.

(51) Int. Cl. G06T 11/00; G06T 5/50

(52) U.S. Cl. CPC G06T 11/008; G06T 5/50; G06T 2207/10081

(57) ABSTRACT

A method of correcting a metal artifact is provided. The method includes obtaining a first image acquired by a first imaging device and a second image acquired by a second imaging device, the second imaging device including a computed tomography (CT) device; registering the first image and the second image; determining a template image based on the registered first image and second image; determining a metal artifact image based on the template image; and generating a corrected image by correcting, based on the metal artifact image, the second image.

### CROSS-REFERENCE TO RELATED APPLICATIONS

This application is a continuation of International Application No. PCT/CN2022/133002, filed on Nov. 18, 2022, the contents of which are hereby incorporated by reference.

### TECHNICAL FIELD

The present disclosure relates to the field of image processing, and in particular, to methods and systems for correcting metal artifacts in digital images.

### BACKGROUND

With the development of radiotherapy technology, radiation treatment has entered the stage of precision therapy. A critical step in this process is delineating the target region, contouring organs, and calculating dosages using computed tomography (CT) images. However, when there are metal implants within the body (such as joint prostheses, dental fillings, spinal fixation screws, etc.), the high absorption rate of X-rays by the metal will prevent the detectors from receiving enough X-ray signals. This leads to the formation of streak artifacts in the reconstructed CT images. These reconstructed CT images with metal artifacts are poor in quality, which may impact subsequent applications of these images. This is particularly problematic in cases involving multiple or complex metals, where severe artifacts lead to inaccurate delineation of target regions and organs. Additionally, the inaccuracy of CT values in the images will result in significant deviations in dosage calculation.

Therefore, it is desired to provide a method for correcting a metal artifact to restore a CT image that is heavily affected by the metal artifact.

### SUMMARY

One of the embodiments of the present disclosure provides a method for correcting a metal artifact. The method may include obtaining a first image acquired by a first imaging device and a second image acquired by a second imaging device, the second imaging device including a computed tomography (CT) device; registering the first image and the second image; determining a template image based on the registered first image and second image; and generating a corrected image by correcting, based on the metal artifact image, the second image.

One of the embodiments of the present disclosure provides a system for correcting a metal artifact. The system may include an acquisition module configured to obtain a first image acquired by a first imaging device and a second image acquired by a second imaging device, the second imaging device including a computed tomography (CT) device; an registration module configured to register the first image and the second image; a template image determination module configured to determine a template image based on the registered first image and second image; a metal artifact determination module configured to determine a metal artifact image based on the template image; and a correction module configured to generate a corrected image by correcting, based on the metal artifact image, the second image.

One of the embodiments of the present disclosure provides a system for correcting a metal artifact. The system may include at least one storage device configured to store computer instructions; and at least one processor configured to be in communication with the at least one storage device, when executing the computer instructions, the at least one processor being configured to perform operations. The operations may include obtaining a first image acquired by a first imaging device and a second image acquired by a second imaging device, the second imaging device including a computed tomography (CT) device; registering the first image and the second image; determining a template image based on the registered first image and second image; determining a metal artifact image based on the template image; and generating a corrected image by correcting, based on the metal artifact image, the second image.

One of the embodiments of the present disclosure provides a device for correcting a metal artifact. The device may include at least one processor and at least one memory, wherein the at least one memory is configured to store computer instructions, the at least one processor is configured to execute at least some of the computer instructions to implement the method for correcting the metal artifact as described in any embodiment of the present disclosure.

One of the embodiments of the present disclosure provides a non-transitory computer-readable storage medium storing computer instructions. When a computer reads the computer instructions in the storage medium, the computer performs the method for correcting the metal artifact as described in any embodiment of the present disclosure.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary system for correcting a metal artifact according to some embodiments of the present disclosure;

FIG. 2 is a schematic diagram illustrating exemplary modules of a system for correcting a metal artifact according to some embodiments of the present disclosure;

FIG. 3 is a flowchart illustrating an exemplary process for correcting a metal artifact according to some embodiments of the present disclosure;

FIG. 4A and FIG. 4B are schematic diagrams illustrating an exemplary first image and an exemplary second image according to some embodiments of the present disclosure;

FIG. 5 is a flowchart illustrating an exemplary process for determining a template image according to some embodiments of the present disclosure;

FIG. 6 is a flowchart illustrating an exemplary process for determining a template image according to some embodiments of the present disclosure;

FIG. 7 is a flowchart illustrating an exemplary process for determining a metal artifact image according to some embodiments of the present disclosure;

FIG. 8 is a flowchart illustrating an exemplary process for correcting a metal artifact according to some embodiments of the present disclosure; and

FIG. 9 shows images illustrating a comparison between effects of methods for correcting a metal artifact according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system”, “device”, “unit” and/or “module” as used herein is a manner used to distinguish different components, elements, parts, sections, or assemblies at different levels. However, if other words serve the same purpose, the words may be replaced by other expressions.

As shown in the present disclosure and claims, the words “one”, “a”, “a kind” and/or “the” are not especially singular but may include the plural unless the context expressly suggests otherwise. In general, the terms “comprise”, “comprises”, “comprising”, “include”, “includes”, and/or “including”, merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

As mentioned hereinabove, when there is a metal implant in the body, since metal absorbs X-rays at a very high rate, when X-rays pass through the metal, almost all the X-rays are absorbed so that the detector doesn't receive enough X-ray signals, and the values calculated by the inverse projection may be abnormally large. When the attenuation coefficient of the tomographic rays changes discontinuously and abruptly, the first-order derivative of the projection data may be in a section of the weak continuity. After filtering, this weak continuity is further amplified, forming light and dark strip artifacts in the reconstructed image.

Embodiments of the present disclosure provide a method and system for correcting the metal artifact. The method for correcting the metal artifact disclosed in embodiments of the present disclosure may be applied to processing a computed tomography (CT) image in which the metal artifact is present. For example, in the case of a kilovoltage CT (kV CT) image, a kilovoltage CT image that is heavily affected by the metal artifact may be restored by determining the portion of the kilovoltage CT image that is affected by the metal artifact by combining it with an image in which the metal artifact is relatively weak (e.g., a megavoltage CT (MV CT) image).

Specifically, a first image is acquired by a first imaging device and a second image is acquired by a second imaging device, the second imaging device being a CT device. The first image and the second image are registered. A template image is determined based on the registered first image and second image. A metal artifact image is determined based on the template image. A corrected image is generated by correcting, based on the metal artifact image, the second image. With the method for correcting the metal artifact shown in the embodiments of the present disclosure, after the first image and the second image are registered, the template image may be determined by the geometrical information of different tissue regions of the first image and the CT value information in the second image, and then the metal artifact image is generated, finally realizing image restoration. The method can achieve a good restoration effect even in the case of multi-metal/big-metal and ensure the accuracy of the CT values of the image while restoring the geometric shape of the image, which meets the requirements of contouring a clinical target region and calculating the dosage.

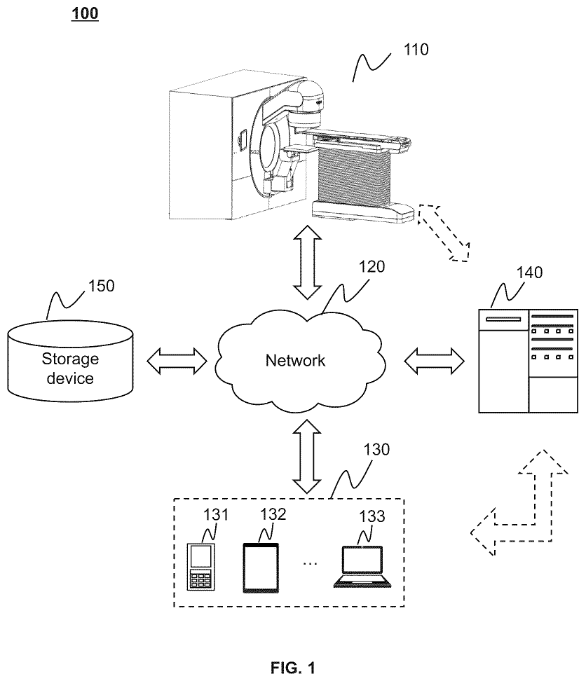

FIG. 1 is a schematic diagram illustrating an exemplary system for correcting a metal artifact according to some embodiments of the present disclosure.

As shown in FIG. 1, a system 100 for correcting a metal artifact (referred to as the system 100 hereinafter) may include an imaging device 110, a network 120, one or more terminals 130, one or more processing devices 140, and a storage device 150.

The imaging device 110 may utilize different media to reproduce the structure of a target object as a specific medical image. In some embodiments, the target object may include a biological object and/or a non-biological object. For example, the target object may include a particular portion of a human body, such as the neck, chest, abdomen, etc., or a combination thereof. At least one metallic implant may be present within the target object. In some embodiments, the imaging device 110 may be a medical device that utilizes various imaging techniques, such as a digital subtraction angiography (DSA) device, computed radiography (CR) systems, digital radiography (DR) systems, computed tomography (CT) devices, ultrasound imaging devices, fluoroscopy imaging devices, magnetic resonance imaging (MRI) devices, positron emission tomography (PET) devices, or any combination thereof. In some embodiments, the imaging device 110 may include a first imaging device and a second imaging device. The first imaging device may be configured to acquire a first image of the target object, and the second imaging device may be configured to acquire a second image of the target object. The first image is an image of the target object with a weak metal artifact, and the second image is a CT image. In some embodiments, the first imaging device is a CT device having a first energy level, the second imaging device is a CT device having a second energy level, and the first energy level is greater than the second energy level. In some embodiments, the CT device having the first energy level is a megavoltage CT device and the CT device having the second energy level is a kilovoltage CT device. In some embodiments, the first imaging device and the second imaging device may be two separate imaging devices or may be two imaging devices on the same imaging device having one of the functions. The imaging device 110 provided above is provided for illustrative purposes only and is not intended to be a limitation of its scope.

In some embodiments, the imaging device 110 may be part of a radiation therapy device, and the radiation therapy device may include the imaging device 110, radiation treatment equipment, a body holder, a support plate, or the like (not labeled in the figures). After the target object (e.g., a patient) lying on the support plate is imaged by the imaging device, the patient may be moved to the radiation treatment equipment by direct and linear movement of the support plate, thereby reducing positioning errors caused by movement of the patient and improving the efficiency of the radiotherapy process.

In some embodiments, the imaging device 110 may include a ray emitting device and a detection device. The ray emitting device may emit radioactive rays that pass through the target object to be received by the detection device. The radioactive rays may include one of particulate rays, photon rays, or the like, or a combination thereof. The particulate rays may include one of neutrons, protons, electrons, muons, heavy ions, or the like, or a combination thereof. The photon rays may include one of X-rays, y-rays, a-rays, B-rays, ultraviolet rays, lasers, etc., or a combination thereof. Merely by way of example, the photon rays may be X-rays, and the ray emitting device may be an X-ray tube or an accelerator tube.

In some embodiments, the imaging device 110 may acquire the first image acquired by the first imaging device and the second image acquired by the second imaging device, and send the first image and the second image to the processing device 140. In some embodiments, the first imaging device includes a megavoltage CT device, and the second imaging device includes a kilovoltage CT device. For example, the first image includes a megavoltage cone-beam CT image, and the second image includes a kilovoltage diagnostic CT image. In some embodiments, the images acquired by the imaging device 110 may be stored in the storage device 140. In some embodiments, the imaging device 110 may receive imaging commands sent from a terminal (not shown in the figures) or the processing device 140 via the network 120, and may send imaging results to the processing device 140 or the storage device 140. In some embodiments, one or more components of the system 100 (e.g., the processing device 140, the storage device 140) may be included in the imaging device 110.

The network 120 may include any suitable network that facilitates the exchange of information and/or data by the system 100. In some embodiments, one or more other components of the system 100 (e.g., the imaging device 110, the terminal 130, the processing device 140, the storage device 150, etc.) may exchange information and/or data with each other via the network 120. For example, the processing device 140 may acquire the first image and/or the second image from the imaging device 110 via the network 120. As another example, the processing device 140 may obtain user instructions from the terminal 130 via the network 120. The network 120 may be and/or include a public network (e.g., the Internet), a private network (e.g., a local area network (LAN), a wide area network (WAN), etc.), a wired network (e.g., Ethernet), a wireless network (e.g., an 802.11 network, a Wi-Fi network, etc.), a cellular network (e.g., an LTE network), a frame relay network, a virtual private network (VPN), a satellite network, a telephone network, a router, a hub, a converter, a server computer, and/or a combination thereof. For example, the network 120 may include one or a combination of one or more of a cable network, a wired network, a fiber optic network, a telecommunication network, a local area network (LAN), a wireless local area network (WLAN), a metropolitan area network (MAN), a public switched telephone network (PSTN), a Bluetooth™ network, a ZigBee™ network, a near-field communication network (NFC), or the like. In some embodiments, the network 120 may include one or more network access points. For example, the network 120 may include wired and/or wireless network access points, such as a base station and/or a network switching point, through which one or more of the components of the system 100 may be accessed by the system 100 to the network 120 for data and/or or information exchange.

In some embodiments, a user may operate the system 100 via the terminal 130. The terminal 130 may include a combination of one or more of a mobile device 131, a tablet 132, a laptop 133, etc. In some embodiments, a corrected image may be presented to the user via the terminal 130. In some embodiments, the mobile device 131 may include one or a combination of one or more of a smart home device, a wearable device, a mobile device, a virtual reality device, an augmented reality device, or the like. In some embodiments, the smart home device may include one or a combination of one or more of a smart lighting device, a smart appliance control device, a smart monitoring device, a smart TV, a smart video camera, an intercom, or the like. In some embodiments, the wearable device may include one or a combination of one or more of a bracelet, footwear, eyewear, helmet, a watch, a garment, a backpack, a smart accessory, or the like. In some embodiments, the mobile device may include one or a combination of one or more of a cell phone, a personal digital assistant (PDA), a gaming device, a navigation device, a point-of-sale (POS) device, a laptop, a tablet, a desktop, or the like. In some embodiments, the virtual reality device and/or the augmented reality device may include one or a combination of a virtual reality headset, virtual reality glasses, a virtual reality eye mask, an augmented reality headset, augmented reality glasses, an augmented reality eye mask, etc. For example, the virtual reality device and/or the augmented reality device may include Google Glass™, Oculus Rift™, Hololens™, Gear VR™, etc. In some embodiments, the terminal 130 may be part of the processing device 140. In some embodiments, terminal 130 may be part of the imaging device 110.

The processing device 140 may process data and/or information obtained from the imaging device 110, the terminal 130, and/or the storage device 150. For example, the processing device 140 may acquire the first image and the second image from the imaging device 110 and generate a template image by registering the first image and the second image. As another example, the processing device 140 may determine a metal artifact image based on the template image and correct the second image based on the metal artifact image. In some embodiments, the processing device 140 may be a server or a group of servers. The group of servers may be centralized or distributed. In some embodiments, the processing device 140 may be local or remote. For example, the processing device 140 may access information and/or data stored at the imaging device 110, the terminal 130, and/or the storage device 150 via the network 120. For example, the processing device 140 may be directly connected with the imaging device 110, the terminal 130, and/or the storage device 150, thereby accessing the information and/or data stored therein. In some embodiments, the processing device 140 may be executed on a cloud platform. For example, the cloud platform may include one or a combination of one or more of a private cloud, a public cloud, a hybrid cloud, a community cloud, a distributed cloud, an interconnected cloud, multiple clouds, or the like. In some embodiments, the processing device 140 may be performed by a computing device having one or more components. In some embodiments, the processing device 140 may be part of the imaging device 110 or the terminal 130.

The storage device 150 may store data, instructions, and/or other information. In some embodiments, the storage device 150 may store data obtained from the terminal 130 and/or the processing device 140. In some embodiments, the storage device 150 may store data and/or instructions executed or used by the processing device 140 to perform the exemplary method described in the present disclosure. In some embodiments, the storage device 150 may include one or a combination of one or more of mass memory, removable memory, volatile read-write memory, read-only memory (ROM), or the like. The exemplary mass memory may include disks, optical disks, solid state drives, or the like. The exemplary removable memory may include flash drives, floppy disks, optical disks, memory cards, zipper disks, magnetic tapes, or the like. The exemplary volatile read-write memory may include random access memory (RAM). The exemplary RAM may include dynamic random access memory (DRAM), double data rate synchronized dynamic random access memory (DDR SDRAM), static random access memory (SRAM), thyristor random access memory (T-RAM), zero capacitance random access memory (Z-RAM), or the like. The exemplary ROM may include mask read-only memory (MROM), programmable read-only memory (PROM), erasable programmable read-only memory (EPROM), electrically erasable programmable read-only memory (EEPROM), compact disc read-only memory (CD-ROM), a digital multi-purpose compact disc, or the like. In some embodiments, the storage device 150 may be implemented on a cloud platform. For example, the cloud platform may include one or a combination of one or more of a private cloud, a public cloud, a hybrid cloud, a community cloud, a distributed cloud, an interconnected cloud, multiple clouds, or the like.

In some embodiments, the storage device 150 may be connected to the network 120 to communicate with one or more other components in the system 100 (e.g., the processing device 140, the terminal 130, etc.). One or more components of the system 100 may access data or instructions stored in the storage device 150 via the network 120. In some embodiments, the storage device 150 may be directly connected with or in communication with one or more other components in the system 100 (e.g., the processing device 140, the terminal 130, etc.). In some embodiments, the storage device 150 may be part of the processing device 140.

The foregoing description of the system 100 is illustrative only. In some embodiments, the system 100 may include one or more other components, or may not include one or more of the components described above. Alternatively, two or more components may be combined into a single component.

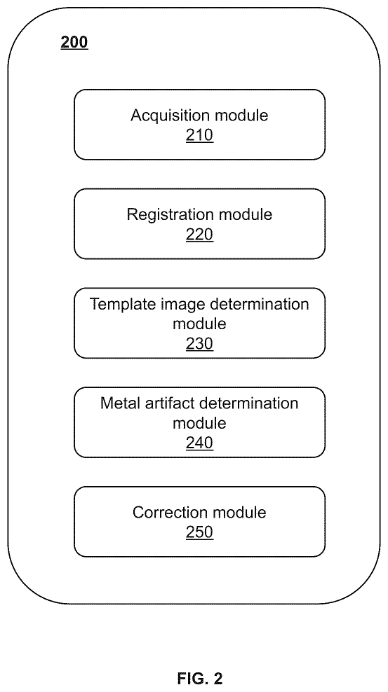

FIG. 2 is a schematic diagram illustrating exemplary modules of a system for correcting a metal artifact according to some embodiments of the present disclosure.

As shown in FIG. 2, a system 200 for correcting a metal artifact (referred to as the system 200 hereinafter) may include an acquisition module 210, a registration module 220, a template image determination module 230, a metal artifact determination module 240, and a correction module 250. In some embodiments, the acquisition module 210, the registration module 220, the template image determination module 230, the metal artifact determination module 240, and the correction module 250 may be implemented by the processing device 140.

The acquisition module 210 may be configured to obtain a first image acquired by a first imaging device and a second image acquired by a second imaging device, the second imaging device being a CT device. In some embodiments, the first imaging device may include a CT device having a first energy level, the second imaging device may include a CT device having a second energy level, and the first energy level is greater than the second energy level. In some embodiments, the CT device having the first energy level may be a megavoltage CT device and CT device having the second energy level may be a kilovoltage CT device. In some embodiments, the first image may include a cone-beam CT image, and the second image may include a diagnostic CT image. More descriptions regarding obtaining the first image and the second image may be found in the detailed description of operation 310, which will not be repeated here.

The registration module 220 may be configured to register the first image and the second image. More descriptions regarding registering the first image and the second image may be found in the detailed description of operation 320, which will not be repeated here.

The template image determination module 230 may be configured to determine a template image based on the registered first image and second image. In some embodiments, the template image determination module 230 may determine regions with different densities based on the first image, and obtain the template image by filling the regions with different densities based on CT values of regions in the second image corresponding to the regions with different densities. More descriptions regarding determining the template image may be found in the detailed description of operation 330 and FIG. 5, which will not be repeated here.

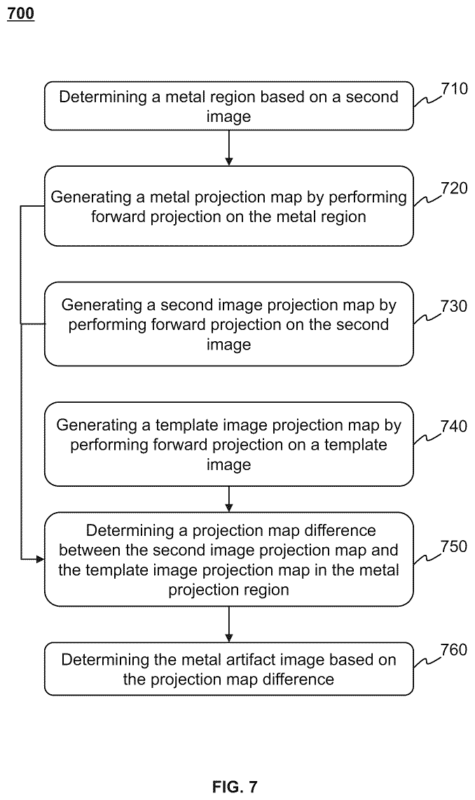

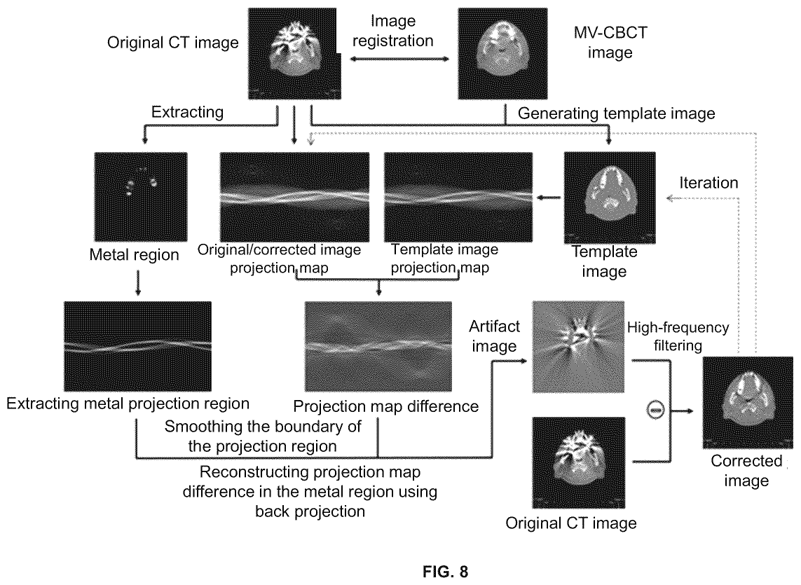

The metal artifact determination module 240 may be configured to determine a metal artifact image based on the template image. In some embodiments, the metal artifact determination module 240 may generate a metal projection map by performing forward projection on the metal region, a non-zero region in the metal projection map being a metal projection region. In some embodiments, the metal artifact determining module 240 may generate a second image projection map by performing forward projection on the second image. In some embodiments, the metal artifact determination module 240 may generate a template image projection map by performing forward projection on the template image. In some embodiments, the metal artifact determination module 240 may determine a projection map difference between the second image projection map and the template image projection map in the metal projection region and determine the metal artifact image based on the projection map difference. More descriptions regarding determining the metal artifact image may be found in the detailed description of operation 340 and FIG. 7, which will not be repeated here.

The correction module 250 may be configured to generate a corrected image by correcting the second image based on the metal artifact image. In some embodiments, the correction module 250 may obtain a processed metal artifact image by filtering the metal artifact image, and obtain the corrected image by correcting, based on the processed metal artifact image, the second image. In some embodiments, the correction module 250 may obtain the corrected image by subtracting the metal artifact image from the second image. In some embodiments, the correction module 250 may update, based on the corrected image, the second image for one or more iterations. More descriptions regarding obtaining the corrected image may be found in the detailed description of operation 350, which is not described herein.

It should be appreciated that the system and its modules illustrated in FIG. 2 may be implemented in a variety of ways. For example, in some embodiments, the system and its modules may be implemented by hardware, software, or a combination of software and hardware.

It should be noted that the above description of the system and its modules is for descriptive convenience only and does not limit the present disclosure to the scope of the cited embodiments. It is to be understood that for a person skilled in the art, after understanding the principle of the system, it may be possible to arbitrarily combine the modules or form a sub-system to be connected to the other modules without departing from this principle. For example, in some embodiments, e.g., the acquisition module 210, the registration module 220, the template image determination module 230, the metal artifact determination module 240, and the correction module 250 disclosed in FIG. 2 may be different modules in a single system, or a single module realizing the functions of two or more of the above-described modules. For example, the individual modules may share a common storage module, and the individual modules may each have a respective storage module. Modifications such as these are within the scope of protection of the present disclosure.

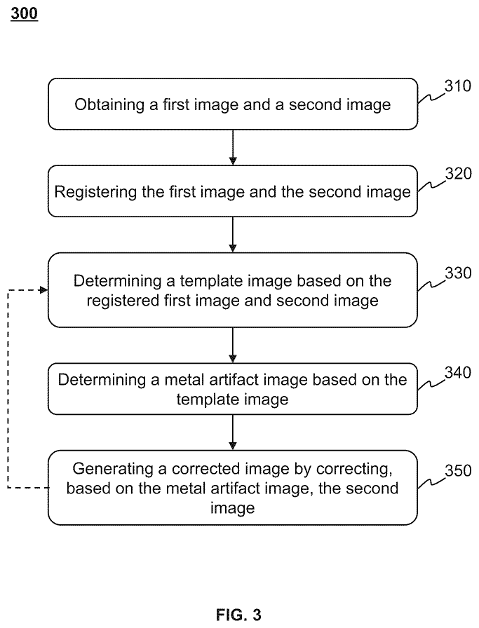

FIG. 3 is a flowchart illustrating an exemplary process for correcting a metal artifact according to some embodiments of the present disclosure.

Process 300 may be performed by a processing device (e.g., the processing device 140). For example, the process 300 may be implemented as a set of instructions (e.g., an application program) that is stored in memory within or external to the system 100. The processing device may execute a set of instructions and, when executing the instructions, may be configured to execute the process 300. The schematic diagram of the operation of process 300 presented below is illustrative. In some embodiments, the process may be accomplished by utilizing one or more additional operations not described and/or omitting one or more operations discussed below. Additionally, the order of the operations of the process 300 illustrated in FIG. 3 and described below is not intended to be limiting.

As described elsewhere in the present disclosure, when a metal implant is present in the human body, the high absorption of X-rays by the metal causes the detector to receive insufficient X-ray signals, which ultimately results in a dark and light streaky artifact in the reconstructed CT image. These reconstructed CT images with metal artifacts are poor in quality, which may impact subsequent applications of these images. This is particularly problematic in cases involving multiple or complex metals, where severe artifacts lead to inaccurate delineation of target regions and organs. Additionally, the inaccuracy of CT values in the images will result in significant deviations in dosage calculation. Therefore, it is desired to provide a method for correcting the metal artifact that achieves a good restoration effect even in the case of multi-metal/big-metal and ensure the accuracy of the CT value of the image while restoring the geometric shape of the image, which meets the requirements of contouring a clinical target region and calculating the dosage.

In 310, a first image acquired by the first imaging device and a second image acquired by the second imaging device are obtained. The second imaging device includes a CT device. In some embodiments, 310 may be performed by the processing device 140 or the acquisition module 210.

The first image and the second image are anatomical images acquired based on the same target object that are capable of reflecting the internal structure of the target object. In some embodiments, the first image and the second image may include an anatomical image of the entire body of the target object or may include an anatomical image of only a portion of the target object, e.g., a neck, a thorax, an abdomen, or the like. The first image is an image with weak metal artifacts, which may be used to assist the second image for correcting the metal artifact, and the second image is a CT image to be corrected for the metal artifact. In some embodiments, the first imaging device may include a CT device, and the first image and the second image may include a CT image obtained by shooting with CT devices having different energy levels. Specifically, the first imaging device may include a CT device having a first energy level, and the second imaging device may include a CT device having a second energy level, and the first energy level is greater than the second energy level. In some embodiments, the first image and the second image may be captured in advance and stored. During the shooting of the first image and the second image, if the target object has the same or substantially the same pendulum position at the time of the two shoots, the position and state of the metal implant as well as the target object in the first image and the second image may be considered to be substantially the same, to facilitate subsequent registration of the first image and the second image to determine the metal artifact image.

In some embodiments, the CT device having the first energy level may include a megavoltage CT device and the CT device having the second energy level may include a kilovoltage CT device. The megavoltage may be within a range of 1˜999 MV and the kilovoltage may be within a range of 1˜999 KV. In some embodiments, the kilovoltage CT device may include a CT device within a range of 70˜140 KV, and the megavoltage CT device may include a CT device within a range of 1˜6 MV. In some embodiments, both the CT device having the first energy level and the CT device having the second energy level may be one of a cone-beam CT device or a fan beam CT device. In some embodiments, the first image may include a cone-beam CT image, and the second image may include a diagnostic CT image. In some embodiments of the present disclosure, the first image may be a megavoltage cone-beam CT image (MV-CBCT image), and the second image may be a kilovoltage CT image (kV-CT image). In some embodiments, the CT device having the first energy level and the CT device having the second energy level may be two separate CT devices or may be two imaging devices on the same imaging device having one of these functions. In some embodiments, the CT device having the first energy level and the CT device having the second energy level may share a support plate, and the target object may be positioned at the CT device having the first energy level and the CT device having the second energy level, respectively, by moving the support plate. The first image and the second image may be obtained without the target object being offline, thereby reducing the positional error, which is conducive to improving the accuracy of the registration and further improving the artifact correction effect.

The first image and the second image are CT images. In order to reconstruct the obtained CT image, an imaging device (e.g., the CT device having the first energy level and the CT device having the second energy level) scans the target object with rays (e.g., X-rays) emitted by a ray emitting device, and then receives rays passing through the target object by a detection device, and ultimately converts the rays into digital signals to be processed to obtain a plurality of voxels. The X-ray attenuation or absorption coefficient of each voxel are arranged in a digital matrix, which is then converted into a pixel matrix, i.e., the reconstructed CT image.

In some embodiments, the MV-CBCT image is an image obtained by reconstruction after a CBCT scan with the aid of the megavoltage rays generated by a linear gas pedal, and the kV-CT image is an image obtained by reconstruction after a CT scan with the aid of the kilovoltage rays generated by a ray tube.

During the imaging process, the metal artifact in the reconstructed image is attenuated due to the greater penetration of the megavoltage rays as compared to the kilovoltage rays. However, the images obtained by the megavoltage rays, with relatively large CT values and low-density resolution, cannot be directly substituted for the kilovoltage CT images for subsequent applications. Therefore, the present disclosure considers the correction of metal artifacts by combining the megavoltage CT images and the kilovoltage CT image.

In some embodiments, the processing device 140 may also correct the second image based on other high-energy images, which only need to have a large energy difference in comparison with the second image. For example, CT images of other energy levels may be used to correct the second image, e.g., the first image may be a megavoltage CT image (greater than 1 MV) while the second image is a kilovoltage CT image. In some embodiments, the processing device 140 may also correct the second image using an image with no metal artifacts or weak metal artifacts, such as a magnetic resonance (MR) image, a positron emission tomography (PET) image, an ultrasound image, etc., that is, the first imaging device may include an MR device, a PET device, or an ultrasound device, etc.

In some embodiments, the acquisition module 210 may obtain the first image and/or the second image directly from the imaging device 110 or may obtain the first image and/or the second image (stored in the storage device 150) from the storage device 150.

In 320, the first image and the second image are registered. In some embodiments, 320 may be performed by the processing device 140 or the registration module 220.

To determine the metal artifact image in the second image, the first image and the second image need to be registered in an image registration manner to help generate the template image. Specifically, the image registration manner may include one or a combination of one or more of a registration manner based on the grayscale information or template, a registration manner based on a transform domain, and a registration manner based on features of the first image and/or the second image.

Since both the first image and the second image may be represented by a pixel matrix, in some embodiments, the processing device 140 may convert, based on the second image (e.g., a pixel matrix of the second image), the first image to a pixel matrix of the same size as the pixel matrix of the second image. Merely by way of example, the first image may be an MV-CBCT image, and the second image may be a kV-CT image. If the pixel matrix of the second image is a matrix of N*P*Q, then the pixel matrix of the first image may be converted also to the matrix of N*P*Q.

In some embodiments, the processing device 140 may register the first image and the second image by rigid registration, and the rigid registration may include a translation transformation and a rotation transformation. Specifically, in the process of rigid registration, the processing device 140 may determine relevant parameters of the rigid registration, such as the amount of translation and the amount of rotation of the images, by selecting corresponding pixel points on the first image and the second image, thereby registering the first image and the second image.

In some embodiments, the processing device 140 may register the first image and the second image with the aid of a deep learning network, such as a registration model. The deep learning network may leverage the inference capabilities of the model to significantly shorten the registration time and improve the registration accuracy. In some embodiments, the deep learning network may include, but is not limited to, one or more of a radial basis function neural network, a deep neural network, a convolutional neural network, a recurrent neural network, a generative adversarial network, etc., or combinations thereof. In some embodiments, the processing device 140 may input the first image and the second image (e.g., the matrix pixel of the first image and the second image) based on the trained registration model to output a registration result (e.g., an overall amount of translation and rotation of the image) of the first image and the second image.

In 330, the template image is determined based on the registered first image and second image. In some embodiments, 330 may be performed by the processing device 140 or the template image determination module 230.

The template image is an intermediate processed image used to generate the metal artifact image on the basis of the first image and the second image. In some embodiments, the processing device 140 may determine regions with different densities based on the first image, the regions with different densities may include a high-density region M1, a medium-density region M2, and a low-density region M3. The high-density region M1 may correspond to a bone tissue and an implanted metal region, the medium-density region M2 may correspond to a soft-tissue region, and the low-density region M3 may correspond to an internal cavity and an external air region.

In some embodiments, the processing device 140 may determine the high-density region, the medium-density region, and the low-density region by processing the first image using local threshold segmentation. In some embodiments, the processing device 140 may also determine the high-density region, the medium-density region, and the low-density region by processing the first image using global threshold segmentation. In some embodiments, the processing device 140 may determine the high-density region and the medium-density region by processing the first image using local threshold segmentation and then determining the low-density region based on a composite image generated by fusing the second image and the first image. Since some metal artifacts may still exist in the first image (e.g., the MV-CBCT image), resulting in an uneven distribution of CT values in the image matrix, it is easy to divide the bone tissue and the metal artifacts into the same region if using global threshold segmentation, which is more prone to errors compared to using local threshold segmentation. Thus, the local threshold segmentation may be used as much as possible to ensure a better optimized correction effect.

In some embodiments, the processing device 140 may obtain the template image by filling the regions with different densities based on CT values of regions in the second image corresponding to the regions with different densities. Specifically, for regions with different densities, the regions with different densities may be filled directly based on the CT values of the corresponding regions in the second image, or an average of the CT values of the pixel points. The CT value may be used to indicate an attenuation coefficient or an absorption coefficient of the substance for the rays. The CT value of a substance reflects the density of the substance, i.e., a higher CT value of a substance corresponds to a higher density of the substance, and the unit of the CT value is the Heinz unit (Hu). The CT value may be calculated by multiplying the difference between the attenuation coefficient of the substance and the attenuation coefficient of the water compared to the attenuation coefficient of the water by a certain indexing factor. Different tissues in the body have different attenuation coefficients, and therefore different CT values. Merely by way of example, the tissues in the human body are ranked according to their CT values, from highest to lowest, and can be bone tissues, soft tissues, cavities, etc. For example, the CT value of water may be about 0 Hu.

More descriptions regarding determining the template image may be found in the detailed description of FIG. 5, which will not be repeated here.

In 340, the metal artifact image is determined based on the template image. In some embodiments, 340 may be performed by the processing device 140 or the metal artifact determination module 240.

The metal artifact image is a portion of the reconstructed image in which the artifact is present due to the effects of the metal implant. As mentioned earlier, the high absorption of radiation by the metal implant makes the reconstructed image have light and dark stripes of artifacts. In contrast, the megavoltage rays are much more penetrating and cause the metal artifact in the reconstructed image to be attenuated, so that the intensity of the metal artifact in the first image obtained using the CT device having the first energy level (e.g., megavoltage) is different from the intensity of the metal artifact in the second image obtained using the CT device having the second energy level (e.g., kilovoltage), thereby enabling the metal artifact image to be determined using the template image obtained based on the first image and the second image. The metal artifact image may be regarded as an image in which these stripe artifacts are extracted to a certain extent individually, which in turn is used for correction of the second image.

In some embodiments, the processing device 140 may determine the metal artifact image by a difference between projection images obtained by performing forward projection respectively on the second image and the template image. Specifically, the processing device 140 may determine a metal region based on the second image and generate a metal projection map by performing forward projection on the metal region, with a non-zero region in the metal projection map being a metal projection region. Further, the processing device 140 may generate a second image projection map by performing forward projection on the second image. Processing device 140 may then perform forward projection on the template image to generate a template image projection map. The processing device 140 may then determine a projection map difference between the second image projection map and the template image projection map in the metal projection region. Finally, the processing device 140 may determine the metal artifact image based on the projection map difference between the second image projection map and the template image projection map in the metal projection region.

More descriptions regarding determining the metal artifact image may be found in the detailed description of FIG. 7, which will not be repeated here.

In 350, the corrected image is generated by correcting, based on the metal artifact image, the second image. In some embodiments, 350 may be performed by the processing device 140 or the correction module 250.

In some embodiments, the processing device 140 may obtain the corrected image by subtracting the metal artifact image from the second image. In order to minimize the effects caused by the metal implant, there is the option of subtracting the portion affected by the metal implant that causes artifacts to be present, i.e., the metal artifact image, directly from the second image (e.g., the kV-CT image) that is required for the subsequent application. The corrected image is a restored second image. Compared to the original second image, the impact caused by the metal implant is significantly attenuated, which may be better applied to subsequent clinical applications, such as diagnostic processing, target zone diagnostic processing, target region delineation, dose calculation, etc.

Due to the insufficient accuracy of registration, threshold segmentation, or the like, in operations 320 and 330, the metal artifact image thus obtained may not be completely overlapped with the second image. If the metal artifact image is subtracted directly from the second image, new strip artifacts may likely be generated. Therefore, it may be considered that the metal artifact image is first filtered to remove the high-frequency components before being corrected.

In some embodiments, before performing the correction, the processing device 140 may first filter the metal artifact image to a certain extent to obtain the processed metal artifact image to reduce the noise generated by the artifact boundary.

Specifically, the processing device 140 may filter the metal artifact image using high-frequency filtering. The high-frequency filtering may include, but is not limited to, one or more of mean filtering, Gaussian filtering. The high-frequency filtering process may be regarded as a fuzzification process. Merely by way of example, the processing device 140 may filter out pixels in the image matrix of the metal artifact image that have CT values greater than a preset filtering threshold. The filtering threshold may be set artificially or may be adjusted based on correction results. In some embodiments, the processing device 140 may filter the metal artifact image by machine learning to achieve high-frequency noise reduction. Specifically, the processing device 140 may input the metal artifact image to the trained machine learning model and may directly output the processed metal artifact image. Relative to the unfiltered artifact image, the filtered image is blurrier at the artifact boundary, the sharpness of the boundary is reduced, and the grayscale of the artifact changes more slowly, which may effectively reduce the errors that may occur in the previous operations.

In some embodiments, the processing device 140 may obtain the corrected image by correcting the second image based on the processed metal artifact image. Specifically, the processing device 140 may subtract the processed metal artifact image directly from the second image to obtain the corrected image. The process may be expressed as the following Equation (1):

$${I}_{correct} = {I}_{CT} - HFF [ {I}_{metal} ) ] , \qquad ( 1 )$$

where Iₘₑₜₐₗ denotes the metal artifact image, HFF denotes the high-frequency filtering processing, I_{CT} denotes the corrected image. From equation (1), it can be seen that the corrected image may be obtained by applying high-frequency filtering to the metal artifact image and then subtracting the metal artifact image processed by high-frequency filtering from the second image. More descriptions regarding determining the metal artifact image and the projection map difference may be found in the detailed description of FIG. 7, which will not be repeated here.

In some embodiments, the processing device 140 may also omit the step of filtering the metal artifact image and subtract the unfiltered metal artifact image directly from the second image to reduce the overall calculation.

In the one complete correction process performed above, since the template image is determined by filling the template image based on the CT values in the second image, then the template image also contains the effect of the metal artifact, which may cause the CT values of the corrected image in the artifact region to be inaccurate. Moreover, in the process of high-frequency filtering of the artifact image may also result in the loss of details of the artifact, and only one correction may not be able to completely remove the effects of the artifact, and some artifacts may still be present in the corrected image. Therefore, the template image may be generated again based on the corrected image and brought into the correction process for iterative correction.

In some embodiments, the processing device 140 may update the second image based on the corrected image for one or more iterations, i.e., operations 330 to 350 may be repeated. Specifically, the processing device 140 may update the template image based on the updated second image. For example, the processing device 140 may obtain an updated template image by filling the template image based on CT values of corresponding regions in the updated second image. Further, the processing device 140 may update the metal artifact image based on the updated second image and the updated template image. For example, the processing device 140 may generate an updated template image projection map and an updated second image projection map by performing forward projection on the updated template image and the updated second image, then determine an updated projection map difference between the updated template image and the updated second image projection map and determine the updated metal artifact image based on the updated projection map difference. There is no need to repeat the determination of the metal region and the metal projection region because the location of the metal implant is fixed. Finally, the processing device 140 may obtain the updated corrected image by correcting the updated second image based on the updated metal artifact image. For example, the updated metal artifact image is filtered and then the updated corrected image is obtained by subtracting the updated metal artifact map from the updated second image.

By performing one or more iterations, the metal artifacts may be gradually removed during each iteration to obtain better correction results. In some embodiments, the number of iterations may be manually set or may be adjusted based on various parameter settings in the calculation process and the correction results. For example, the number of iterations may be set to 5, and the corrected image obtained after repeating operations 330 to 350 up to 5 times may be regarded as the final corrected image. The corrected image is considered to have a better restore effect and may be subsequently used for clinical applications, such as clinical target region delineation and dosage calculation. In some embodiments, the iteration may be subsequently optimized by a machine learning process. For example, the number of iterations is adaptively set by a machine learning model.

The method for correcting the metal artifact provided by embodiments of the present disclosure realizes image restoration by registering the first image having the first energy level and the second image having the second energy level, obtaining a template image utilizing geometrical information of different tissue regions of the first image and CT value information in the second image, and then generating the metal artifact image. Meanwhile, the second image may be further updated for iterative correction based on the corrected image, to progressively remove the artifact and improve the correction effect of the image. The method also achieves a good restoration effect even in the case of multi-metal/big-metal in the target object and ensure the accuracy of the CT values of the image while restoring the geometric shape of the image, which meets the requirements of contouring a clinical target region and calculating the dosage.

It should be noted that the foregoing description of the process 300 is intended to be exemplary and illustrative only and does not limit the scope of application of the present disclosure. For a person skilled in the art, various corrections and changes may be made to the process 300 under the guidance of the present disclosure. However, these corrections and changes remain within the scope of the present disclosure. For example, the process of operations 320 through 350 can be repeated.

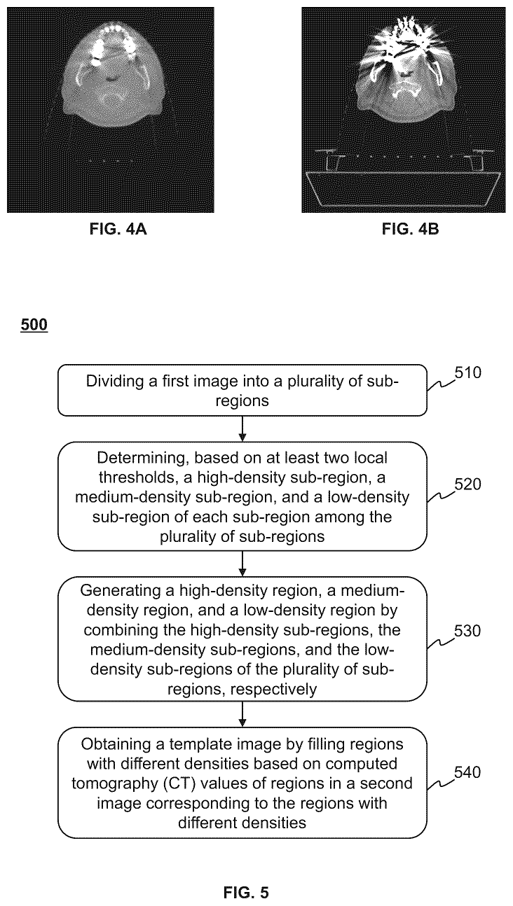

FIG. 4A and FIG. 4B are schematic diagrams illustrating an exemplary first image and an exemplary second image according to some embodiments of the present disclosure.

FIG. 4A is a schematic diagram of a first image. The first image is an MV-CBCT image. FIG. 4B is a schematic diagram of a second image. The second image is a kV-CT image. According to the comparison of FIG. 4A and FIG. 4B, it can be seen that the metal artifact in the MV-CBCT image is weaker relative to the metal artifact in the kV-CT image, due to the greater penetration of the megavoltage rays. Therefore, it is an option to use the MV-CBCT image to process the kV-CT image to minimize the metal artifact in the kV-CT image.

FIG. 5 is a flowchart illustrating an exemplary process for determining a template image according to some embodiments of the present disclosure.

Process 500 may be performed by a processing device (e.g., the processing device 140). For example, the process 500 may be implemented as a set of instructions (e.g., an application program) that is stored in a memory internal or external to the system 100. The processing device may execute the set of instructions and, when executing the instructions, may be configured to execute the process 500. The schematic of the operation of process 500 presented below is illustrative. In some embodiments, the process may be accomplished by utilizing one or more additional operations that are not described and/or by omitting one or more operations discussed below. Additionally, the order of the operations of the process 500 illustrated in FIG. 5 and described below is not intended to be limiting. In some embodiments, the process 500 may be performed to implement operation 330 of the process 300.

In 510, the first image is divided into a plurality of sub-regions. In some embodiments, 510 may be performed by the processing device 140 or the template image determination module 230.

In some embodiments, the processing device 140 may divide the whole first image into N sub-regions, and the N sub-regions may be of equal or different sizes. Specifically, the processing device 140 may automatically divide the first image in a preset manner. For example, the first image may be divided into N grids (including 9 grids, 16 grids, etc.).

In some embodiments, the processing device 140 may divide the first image into the plurality of sub-regions based on the contouring information. The contouring operation may be performed manually. Merely by way of example, a certain region of bone tissue that can be distinguished by the naked eye may be outlined and set as a sub-region, and a region with a more obvious boundary may also be divided into different sub-regions based on the boundary in the image. Division based on the contouring information is more fine-grained as compared to the division results by way of presetting.

In some embodiments, the processing device 140 may automate the division through machine learning. For example, the processing device 140 may process with the aid of a trained region division model, inputting the first image into the trained region division model to generate a plurality of sub-regions.

In 520, a high-density sub-region, a medium-density sub-region, and a low-density sub-region of each sub-region among the plurality of sub-regions are determined based on at least two local thresholds. In some embodiments, 520 may be performed by the processing device 140 or the template image determination module 230.

In some embodiments, the processing device 140 may have M local thresholds in each sub-region, respectively, to further divide each sub-region into M+1 sub-regions with different densities. M is a natural number greater than or equal to 2. In some embodiments, the value of M may be within a range of 2˜10. In some embodiments, the value of M may be within a range of 2˜4. For example, when M is 2, each sub-region may be further divided into 3 sub-regions with different densities, which may include a high-density sub-region, a medium-density sub-region, and a low-density sub-region. The number of local thresholds within each sub-region may be the same or different.

In some embodiments, the processing device 140 may compare a pixel point in each sub-region with M local thresholds within the sub-region and classify the pixel point into one of the M+1 regions based on the comparison results, thereby determining the distribution of regions within that sub-region. Merely by way of example, the processing device 140 may first divide the first image into 9 sub-regions, with two local thresholds Tmax and Tmin set within the first sub-region. When the value of a pixel point in the first sub-region is greater than Tmax, then the pixel point may be designated to the high-density sub-region. When the value of a pixel point in the first sub-region is less than or equal to Tmax and greater than or equal to Tmin, i.e., within the interval of Tmax and Tmin, the pixel point may be designated to the medium-density sub-region. When the value of a pixel point in the first sub-region is less than Tmin, then the pixel point may be designated to the low-density sub-region. After designating each pixel point in the first sub-region, division of the high-density sub-region, the medium-density sub-region, and the low-density sub-region in the sub-region may be completed.

In some embodiments, the processing device 140 may set the same or different local thresholds according to the conditions of each sub-region. For example, for a sub-region that is automatically divided in a preset manner, the same local threshold may be set for sub-regions where the distribution of densities may be the same in each sub-region. For sub-regions that are divided by the contouring information, if there is a distinct metal region in a sub-region, a higher local threshold may be set, and if a sub-region is distinctly free of the metal region and has mostly soft tissue, then a lower local threshold may be set. Merely by way of example, the local threshold may be set to Tₘₐₓ′ and Tₘᵢₙ′, and Tₘᵢₙ′>Tₘᵢₙ′, Tₘᵢₙ′>Tₘᵢₙ, Tₘᵢₙ′<Tₘᵢₙ.

In some embodiments, the local threshold within each sub-region may be determined based on the maximum and minimum values of the pixel points within each sub-region. For example, the threshold may be determined based on the sum of the maximum values of the pixel points and the minimum values of the pixel points multiplied by a threshold factor. Merely by way of example, the local threshold Tₘₐₓ may be set to (maximum value of the pixel point+minimum value of the pixel point)*a first coefficient, and the local threshold Tₘᵢₙ may be set to (maximum value of the pixel point+minimum value of the pixel point)*a second coefficient, and the first coefficient is greater than the second coefficient. The threshold coefficients (e.g., the first coefficient and the second coefficient) may be set artificially and may be adjusted by the conditions within the sub-region. In some embodiments, the processing device 140 may further utilize a machine learning approach to determine the local threshold and/or the threshold coefficient.

In some embodiments, the regions with different densities generally need to include at least three regions, including a high-density region M1, a medium-density region M2, and a low-density region M3 to correspond to the bone tissue and metal implanted region, the soft tissue region, and the internal cavity and external air region, respectively. Accordingly, for each sub-region, there may be at least two local thresholds set to divide the three density regions described above for distinguishing the bone tissue, the soft tissue, the air, or the like. Further, the processing device 140 may also be provided with more than two local thresholds, e.g., three, four, five local thresholds, to divide regions with more densities, e.g., such as four, five, six regions with different densities. The division of more density regions may have a finer division result. The number of the local thresholds is related to the number of regions with different densities. If M local thresholds are set, then the number of regions with different densities is M+1.

In 530, the high-density region, the medium-density region, and the low-density region are generated by combining the high-density sub-regions, the medium-density sub-regions, and the low-density sub-regions of the plurality of sub-regions, respectively. In some embodiments, 530 may be performed by the processing device 140 or the template image determination module 230.

In some embodiments, when all pixel points within each sub-region are determined, the processing device 140 may combine the high-density sub-regions within all the sub-regions to generate a high-density region, combine the medium-density sub-regions within all the sub-regions to generate a medium-density region, and combine the low-density sub-regions within all sub-regions to generate a low-density region.

Taking the above 9 sub-regions as an example, when all the pixel points in the 9th sub-region are determined, the division of the high-density sub-region, the medium-density sub-region, and the low-density sub-region within each sub-region may be completed. By combining the high-density sub-regions within the 9 sub-regions, combining the medium-density sub-regions within the 9 sub-regions, and combining the low-density sub-regions within the 9 sub-regions, the division of the high-density region, the medium-density region, and the low-density region of the whole first image may be completed.

In some embodiments, the processing device 140 may further generate a bone tissue and metal mask for the high-density region, a soft tissue mask for the medium-density region, and an air mask for the low-density region. It may also be possible to eliminate the need for generating separate mask images since only the division of regions with different densities is needed for the subsequent calculation process. In some embodiments, the processing device 140 may determine the high-density region and the medium-density region by processing the first image using the local threshold segmentation, generating a composite image by fusing the second image and the first image, and determining the low-density region by processing the composite image using local threshold segmentation. Description regarding determining the regions with different densities is consistent with that described in the operations above.

The first image shown in FIG. 4A (i.e., the MV-CBCT image) lacks a bedplate portion (a bottom portion of FIG. 4B) relative to the second image shown in FIG. 4B (i.e., the kV-CT image). In some embodiments, the processing device 140 may generate a composite image by integrating/copying the information of the bedplate region in the second image at the same location in the first image before determining the regions different densities. Alternatively, the processing device 140 may integrate/copy the information of the bedplate region in the air mask into the bone tissue and the metal mask as well as the soft tissue mask after generating the air mask. Integrating/copying the information of the bedplate region in the second image into the first image ensures that the data in the first image and the second image are equivalent to each other to avoid problems during subsequent image processing.

In 540, a template image is obtained by filling the regions with different densities based on CT values of regions in the second image corresponding to the regions with different densities. In some embodiments, 540 may be performed by the processing device 140 or the template image determination module 230.

After registering the first image and the second image in 320, the size of the pixel matrix of the first image is the same as the size of the pixel matrix of the second image. As a result, each pixel point of regions with different densities in the first image determined in 530 has a unique corresponding pixel point in the second image, and thus, regions with different densities in the second image corresponding to the first image can be determined. Specifically, the processing device 140 may determine regions with different densities of the second image based on the regions with different densities of the first image. The processing device 140 may determine, based on the region to which each pixel point in the first image belongs, that the corresponding pixel point in the second image belongs to a corresponding region. The regions with different densities of the second image may include a first region M1′, a second region M2′, and a third region M3′. The high-density region M1 of the first image corresponds to the first region M1′ of the second image, the medium-density region M2 of the first image corresponds to the second region M2 of the second image′, and the low-density region M3 of the first image corresponds to a third region M3′ of the second image. Merely by way of example, if the pixel point Z in the first image belongs to the low-density region, the corresponding pixel point Z′ in the second image may be determined to belong to the third region M3′.

Because of the large difference in the CT values of the different tissues in the first image and second image, it may be considered to fill the pixel values of regions with different densities of the first image based on the CT values of the second image. Specifically, the processing device 140 may fill the high-density region M1 based on the CT values of the first region M1′ in the second image, and the first region M1′ is a region in the second image corresponding to the high-density region M1. Further, the processing device 140 may fill the medium-density region M2 based on the average of the CT values of the pixel points of the second region M2′ in the second image, and the second region M2′ is a region in the second image corresponding to the medium-density region M2. Finally, the processing device 140 may fill the low-density region M3 based on the average of the CT values of the pixel points of the third region M3′ in the second image, and the third region M3′ is a region in the second image corresponding to the low-density region M3. In some embodiments, the processing device 140 may generate the template image based on the filled high-density region, medium-density region, and medium-density region.

Specifically, the processing device 140 may fill regions with different densities according to the following Equation (2):

$${I}_{template} = {I}_{CT} \& {I}_{template} ( i , j ) = \{ \begin{matrix}{I}_{CT} ( i , j ) , & ( i , j ) ∈ M {1}^{′} \\ \frac{{\sum }_{( i , j ) ∈ M {2}^{′}} {I}_{CT} ( i , j )}{{N}_{M {2}^{′}}} , & ( i , j ) ∈ M {2}^{′} \\ \frac{{\sum }_{( i , j ) ∈ M {3}^{′}} {I}_{CT} ( i , j )}{{N}_{M {3}^{′}}} , & ( i , j ) ∈ M {3}^{′}\end{matrix} , \qquad ( 2 )$$

where Iₜₑₘₚₗₐₜₑ denotes the template image, I_{CT} denotes the pixel matrix of the second image, (i, j) denotes different pixel points in the pixel matrix, N_{M2}, and N_{M3}, denote the pixel points in the second region M2′ and the number of pixels in third region M3′. j, and N_{M2}, and N_{M3}, take a range of values related to the size of the image. Merely by way of example, if the image is a 512*512*512 pixel matrix, then i and j range from 1 to 512, and N_{M2}, and N_{M3}, range from 1 to 5123. If the image is a 1024*1024*1024 pixel matrix, then i and j range from 1 to 1024, and N_{M2}, and N_{M3}, range from 1 to 10243. In the process of generating the template image, the second image is first used as the template image, and then the different regions are filled according to the above Equation (2), respectively.

It should be noted that the foregoing description of the process 500 is intended to be exemplary and illustrative only and does not limit the scope of application of the present disclosure. For a person skilled in the art, various corrections and changes can be made to the process 500 under the guidance of the present disclosure. However, these modifications and changes remain within the scope of the present disclosure.

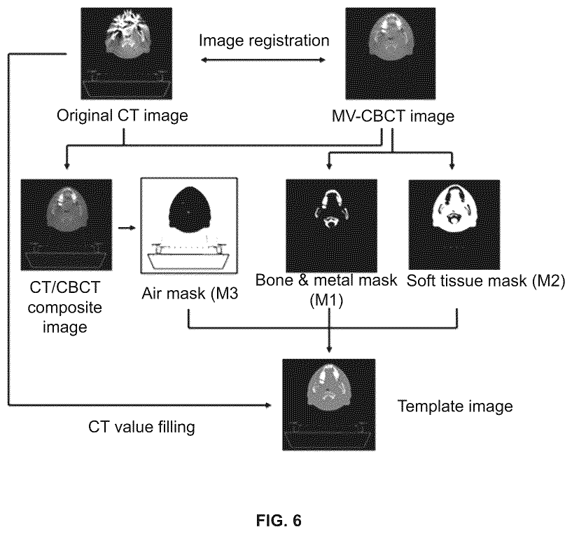

FIG. 6 is a flowchart illustrating an exemplary process for determining a template image according to some embodiments of the present disclosure.

FIG. 6 shows a process for determining a template image described in embodiments of the present disclosure. The process includes one or more of the following operations. First, the first image (e.g., the MV-CBCT image) and the second image (e.g., an original CT image) are registered. Further, regions with different densities of the first image are determined based on the registered first image and second image. Specifically, the regions with different densities include a high-density region M1 (corresponding to a bone tissue and metal mask), a medium-density region M2 (corresponding to a soft tissue mask), and a low-density region M3 (corresponding to an air mask). The first image and the second image may first be fused to generate a composite image (i.e., a CT/CBCT composite image), and then the low-density region M3 may be determined based on the composite image. Finally, the template image may be generated by filling the regions with different densities, including a high-density region M1, a medium-density region M2, and a low-density region M1, based on the CT values of the second image.

FIG. 7 is a flowchart illustrating an exemplary process for determining a metal artifact image according to some embodiments of the present disclosure.

Process 700 may be performed by a processing device (e.g., the processing device 140). For example, the process 700 may be implemented as a set of instructions (e.g., an application program) that is stored in memory within or external to the system 100. The processing device may execute the set of instructions and, when executing the instructions, may be configured to execute process 700. The schematic diagram of the operation of process 700 presented below is illustrative. In some embodiments, the process may be accomplished by utilizing one or more additional operations that are not described and/or by omitting one or more operations discussed below. Additionally, the order of the operations of process 700 illustrated in FIG. 7 and described below is not intended to be limiting. In some embodiments, process 700 may be performed to implement operation 340 in process 300.

In the embodiments of the present disclosure, since the second image is affected by the metal mainly in the regions located on the same ray path as the metal, in order to correct the effect of the metal on the medium-density region and the low-density region, it is necessary to first determine the metal projection region and then based on the projection map difference between the second image and the template image in the metal projection region, metal artifacts in non-high-density regions are obtained for subsequent correction. Steps regarding the determination of the metal projection region, or the like, for correction are described in detail as follows.

In 710, a metal region is determined based on the second image. In some embodiments, 710 may be performed by the processing device 140 or the metal artifact determination module 240.

The metal region is a region of the second image that includes only metal portions (e.g., joint prostheses, dental fillings, vertebral fixation bolts, etc.), and the metal region does not include the bone tissue region and artifacts. The processing device 140 may extract the metal region from the first region M1′ or bone tissue and metal mask. While the presence of metal artifact affects the quality of the reconstructed image and has an impact on the subsequent application of the image, in the process of correcting the metal artifact of the image, the information that the metal implant is actually inside the target object needs to be preserved.

In some embodiments, the processing device 140 may determine the metal region Mₘₑₜₐₗ by threshold segmentation. Since the second image is a kV-CT image and the CT value corresponding to the metal in the second image is very high, which may even reach tens of thousands of Heinz units, it may be considered to set a metal threshold to remove the bone tissue and metal artifact in the first region M1′. Relatively, since the first image is an image obtained by a megavoltage CT device, the difference between the CT values of the metal portion and the bone tissue is not so obvious and is uneasy to be differentiated, it is necessary to process the second image separately, and it is not possible to directly extract the metal portion in determining the regions with different densities.

Specifically, when determining the metal region Mₘₑₜₐₗ by the segmentation, the processing device 140 may compare each pixel point in the first region M1′ or the bone tissue and metal mask portion of the first image with a preset metal threshold and, based on the comparison result, determine whether the pixel point belongs to the metal region. Merely by way of example, if a pixel point is greater than or equal to the metal threshold, the pixel point may be determined to belong to the metal region and be retained. If a pixel point is smaller than the metal threshold, the pixel point may be determined not to belong to the metal region and be screened out. After comparing all the pixels in the first region M1′, all the retained pixels may then form the metal region.

In some embodiments, the metal threshold may be set manually or adjusted according to the situation in the first image, for example, the metal threshold may be directly set to 10000 Hu.

In 720, a metal projection map is generated by performing forward projection on the metal region. The non-zero region in the metal projection map is a metal projection region. In some embodiments, 720 may be performed by the processing device 140 or the metal artifact determination module 240.

The metal projection map is a projection sinogram obtained by performing the forward projection on the metal region. The metal projection sinogram is a projection sinogram presenting the projection data, which may represent the projection data obtained at different projection angles. The metal projection region in a projection domain can be determined by combining the non-zero regions in the metal projection sinogram. In some embodiments, the horizontal coordinate in the metal projection map may indicate a projection angle of the detector, and the vertical coordinates may indicate a pixel position of the detector.

In some embodiments, as described in 350, in the process of performing the iterative correction, there is no need to repeat the determination of the metal region and the metal projection region based on the updated second image, as the location where the metal implant is located is unchanged.

In 730, a second image projection map is generated by performing forward projection on the second image. In some embodiments, 730 may be performed by the processing device 140 or the metal artifact determination module 240.

In some embodiments, the processing device 140 may generate a second image projection map by performing forward projection on the second image (e.g., a kV-CT image) to process the image data in the projection domain. The second image projection map is a projection sinogram obtained by projecting the complete second image.

In some embodiments, operations 710, 720, and 730 are performed on the second image, and are not associated with the operation of determining the template image, thus, operations 710, 720, and 730 may be performed, after the registration of the first image and the second image in 320, and need not be performed after the operation 330 of determining the template image, but need only be completed before operation 750. In some embodiments, operations 710, 720, 730, and 330 may be performed synchronously.

In 740, a template image projection map is generated by performing forward projection on the template image. In some embodiments, 740 may be performed by the processing device 140 or the metal artifact determination module 240.

In some embodiments, by further performing forward projection on the template image obtained in 330, the processing device 140 may generate a template image projection sinogram for processing the second image projection map in the projection domain. The template image projection map is a projection sinogram obtained after performing forward projection on the template image.

In some embodiments, 740 may be performed synchronously with operations 710, 720, and 730, but after operation 330.

In 750, a projection map difference between the second image projection map and the template image projection map in the metal projection region is determined. In some embodiments, 750 may be performed by the processing device 140 or the metal artifact determination module 240.

Since the CT values of the different regions in the template image are obtained by filling in the template image with the CT values or average CT values of the corresponding regions in the second image (e.g., the kV-CT image). When performing forward projection on the template image and the second image, the differences in the integral values on the same beam paths of the template image and the second image mainly come from the metal artifact, which are all caused by signal deviations on the beam paths through the metal. The same beam path may be understood to be within the same region, i.e., the same density region, and the difference in the integral value is the difference in the integral value on the ray attenuation in the projection process, which is mainly used to show that the grayscales of the two images are different. Therefore, the second image may be corrected by simply extracting the difference in the sinogram of the metal projection region. Equation (2) shows that for the template image and the second image, the CT values of the high-density regions are the same, while the CT values of the medium-density regions and low-density regions are different, thus the metal artifacts in the medium-density regions and low-density regions may be determined by determining the difference in the projection maps.

In some embodiments, the processing device 140 may determine the projection map difference based on the second image projection map, the template image projection map, and the metal projection region determined in 720. Specifically, the projection map difference may be obtained based on the following Equation (3):

P_{MetalDiff}(θ,k)=FP(I_{CT})−FP(Iₜₑₘₚₗₐₜₑ),(θ,k)ϵFP(Mₘₑₜₐₗ)≠0, (3)
wherein P_{MetalDiff} denotes the projection map difference, FP denotes a forward projection operator, θ denotes a pixel position of the detector. θ may be within a range of 0˜360°, and the range of k is related to the resolution of the detector. In some embodiment, k may be within a range of 256˜2048. FP(I_{CT}) denotes the second image projection map, FP(Iₜₑₘₚₗₐₜₑ) denotes the template image projection map, FP(Mₘₑₜₐₗ) denotes the metal projection map, and FP(Mₘₑₜₐₗ)≠0 denotes the non-zero region in the metal projection map, i.e., the metal projection region. By directly subtracting the values of the second image projection map and the template image projection map in the metal projection region, the projection map difference P_{MetalDiff} between the second image projection map and the template image projection map in the metal projection region may be obtained.

In 760, a metal artifact image is determined based on projection map difference. In some embodiments, 760 may be performed by the processing device 140 or the metal artifact determination module 240.

In some embodiments, the processing device 140 may take the projection map difference P_{MetalDiff} obtained in 750 and perform a direct back projection reconstruction to determine the metal artifact image, and then substitute the determined metal artifact image into operation 350 to correct the second image to obtain the corrected image.

However, in the case of CT imaging of a target object that is normally free of metal, it is essentially unlikely that there will be a great steep drop in CT values caused by the metal region, but rather a smoother decline. Therefore, the presence of the metal region results in a truncation of the projection value in the boundary region of the projection map difference, and without smoothing, there is a risk of introducing new striping artifacts during subsequent processing. In some embodiments of the present disclosure, it is considered that the smoothing of the boundary region in the projection map difference is performed before determining the metal artifact image, so that the projection value of the boundary region may be slowly reduced to 0, thereby avoiding the introduction of the new striped artifact degrading the image quality.

In some embodiments, the processing device 140 may smooth a boundary region in the projection map difference to obtain a processed projection map difference. Further, the processing device 140 may obtain a metal artifact image by performing the inverse projection reconstruction based on the processed projection map difference. In some embodiments, the processing device 140 may smooth the boundary region by linear interpolation or normalized interpolation. In some embodiments, the processing device 140 may determine an extended distance between an upper boundary and a lower boundary of the boundary region of the projection map difference and obtain the processed projection map difference by performing the linear interpolation on the extended distance between the upper boundary and the lower boundary.

Specifically, the processed projection map difference may be obtained by performing the linear interpolation based on the following Equation (4):

$$( 4 )$$

$${P}_{interp} ( θ , k ) = \{ \begin{matrix}{P}_{MetalDiff} ( θ , {k}_{n 1} ) - \frac{{P}_{MetalDiff} ( θ , {k}_{n 1} )}{{Δ}_{n 1}} ( k - {k}_{n 1} ) , & k ∈ [ {k}_{n 1} - {Δ}_{n 1} , {k}_{n 1} ] \\ {P}_{MetalDiff} ( θ , {k}_{n 2} ) - \frac{{P}_{MetalDiff} ( θ , {k}_{n 1} )}{{Δ}_{n 2}} ( k - {k}_{n 2} ) , & k ∈ [ {k}_{n 2} , {k}_{n 2} + {Δ}_{n 2} ] \\ {P}_{MetalDiff} ( θ , k ) & k ∈ others\end{matrix} ,$$

wherein Pᵢₙₜₑᵣₚ denotes the processed projection map difference after linear interpolation, kₙ₁ and kₙ₂ denote the upper boundary and the lower boundary of a section of the metal region at a certain projection angle, Δₙ₁, and Δₙ₂ denote the extended distances between the upper boundary and the lower boundary. kₙ₁ and kₙ₂ may be within a range of 256˜2048, and Δₙ₁ and Δₙ₂ may be within a range of 1˜100. The extended distance between the upper boundary and the lower boundary may be manually set or adjusted according to the correction results. In some embodiments, the processing device 140 may also determine the extended distance between the upper boundary and the lower boundary based on a machine learning model. In some embodiments, the machine learning model may include, but is not limited to, a neural network model, a convolutional neural network model, a visual geometric group network model, a full-resolution residual network model, a masked region convolutional neural network model, multi-dimensional recurrent neural network model, or combinations thereof. In some embodiments, the processing device 140 may input the projection map difference to the machine learning model to output the extended distance between the upper boundary and the lower boundary. The machine learning model may be obtained by training based on a plurality of samples of projection map differences with labels (e.g., correction results).

In some embodiments, the processed projection map difference is subjected to the inverse projection reconstruction to obtain the metal artifact image, i.e., the metal artifact image Iₘₑₜₐₗ may be denoted as Iₘₑₜₐₗ=BP(Pᵢₙₜₑᵣₚ), and BP denotes an inverse projection reconstruction operator. Using the smoothed projection map to determine the metal artifact image may effectively avoid the introduction of new artifacts due to truncation of projection value processing.

It should be noted that the foregoing description of the process 700 is intended to be exemplary and illustrative only and does not limit the scope of application of the present disclosure. For a person skilled in the art, various corrections and changes may be made to the process 700 under the guidance of the present disclosure. However, these corrections and changes remain within the scope of the present disclosure. For example, 710 may be performed synchronously with 720, 730, and 740.

FIG. 8 is a flowchart illustrating an exemplary process for correcting a metal artifact according to some embodiments of the present disclosure.

FIG. 8 shows a process for determining a template image described in embodiments of the present disclosure. The process includes one or more of the following operations. First, the first image (e.g., the MV-CBCT image) and the second image (e.g., the original CT image) may be registered. Then, the template image is determined based on the registered first image and second image. The template image projection map and the second image projection map (i.e., the original image projection map) may be generated by performing forward projection on the template image and the second image. At the same time, the metal region may be extracted from the second image, and the metal projection region may be determined by performing forward projection on the metal region. Next, the projection map difference between the second image projection map and the template image projection map in the metal projection region may be determined based on the template image projection map and the second image projection map. After smoothing the boundary of the projection region of the projection map difference, the projection map difference is then reconstructed by using back projection to generate the metal artifact image. The metal artifact image may be further processed with high-frequency filtering, and finally the corrected image may be obtained by subtracting the processed metal artifact image from the second image. After a round of correction is performed, the corrected image may also be updated to a new second image for one or more iterations. Specifically, an updated template image and an updated second image projection map may be generated based on the corrected image.

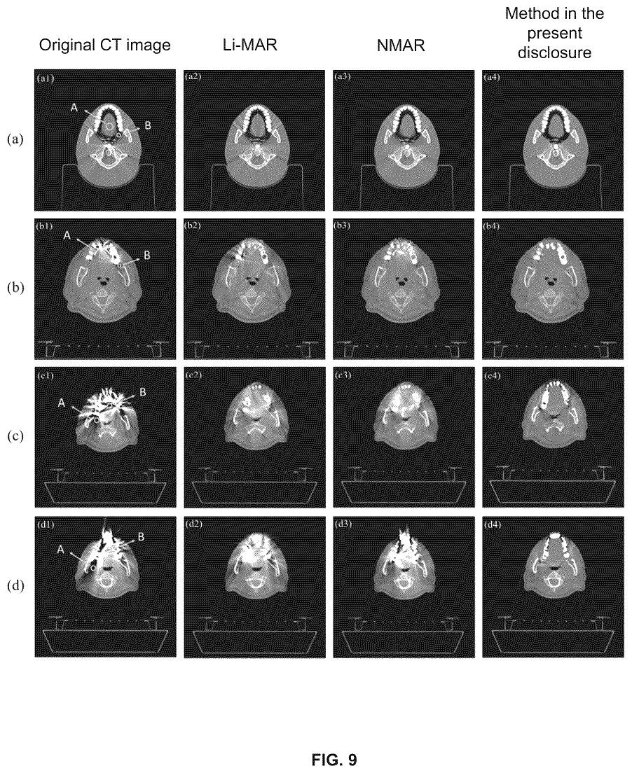

FIG. 9 shows images illustrating a comparison between effects of methods for correcting a metal artifact according to some embodiments of the present disclosure. To further understand the effect of the method for correcting the metal artifact described in the embodiments of the present disclosure, it is considered to use a simulated phantom and a real human body for validation. In the validation process, metal spheres were placed inside the simulation phantom, and metal dentures were implanted in the real human body.

As shown in FIG. 9, group (a) shows the data of the simulation phantom, group (b) shows the data of the real human body 1, and groups (c) and (d) show the data of different layers of the real human body 2. From the first column of the original CT images, it can be seen that there are metal artifacts due to the placement of the metal spheres in the original CT images of the simulation model, and there are metal artifacts in both the real human body 1 and the real human body 2 due to the implantation of metal dentures. The second column, the third column, and the fourth column are images obtained after processing the same layer of data using linear interpolation (LIMAR), the priori normalized image interpolation (NMAR), and the method for correcting the metal artifact described in the embodiments of the present disclosure, respectively, and all of them have been adjusted to the same window widths and window positions. From FIG. 9, it can be seen that the metal artifacts in the images processed by the linear interpolation and the normalization are weakened in comparison with those in the original CT images, but the metal artifacts in the overall images are still relatively obvious, which may have an impact on the subsequent applications. In contrast, in the image data processed by the method for correcting the metal artifact described in the embodiments of the present disclosure, the metal artifacts have been greatly attenuated, and it is almost impossible to visibly see the metal artifacts.

Specifically, on the one hand, using the linear interpolation, the metal region projection may be obtained by linearly interpolating the values of the projections on two sides of the metal region projection. Using linear interpolation attenuates the artifacts brought about by the inverse projection reconstruction in the metal region to a certain extent, but the interpolated region results in the loss of projection information. The artifacts caused by a single metal implant with a relatively small volume may achieve a better restoration effect, but for the case of multiple metal or metal implants with a large volume, the application of linear interpolation may cause the loss of projection information. On the other hand, the original image may be used in a priori image normalization interpolation to obtain the a priori image, normalize the projection value of the original image by the projection value of the priori image, and then perform metal region interpolation. Using normalized interpolation reduces the discontinuity of the metal region interpolation, with an image restoration effect better than that of linear interpolation. However, when the metal artifacts are serious, it is difficult to obtain an ideal priori image, and the image restoration effect is limited. Relatively, using the method for correcting the metal artifact described in the embodiments of the present disclosure, after the first image having the first energy level and the second image having the second energy level are registered, based on the geometrical information of different tissue regions in the first image and the CT value information in the second image to obtain the template image, and then generate the metal artifact image to ultimately realize image restoration. The method may achieve a good restoration effect even in the case of multi-metal/big-metal and ensure the accuracy of the CT values of the image while restoring the geometric shape of the image, which may meet the requirements of contouring the clinical target region and calculating dosage.

Further analyzing the image data, different regions A and B are selected in each set of images, and the CT values and the mean squared deviation of the CT values within the region are calculated. As shown in FIG. 9, the regions A and B of each set of images are consistent with the original CT images of that set of images. The mean CT values and the mean square deviation of the different groups of data in regions A and B are shown in Table 1 below:

TABLE 1
Mean CT values and mean square deviation of different groups of data in different regions

| Mean CT values | | | | | Method in | |
|---|---|---|---|---|---|---|
| and mean square | | Original | | | the present | Reference |
| deviation/HU | | CT image | LIMAR | NMAR | disclosure | CT value |
| (a) | Region A | 28.4 ± 58.7 | 12.9 ± 30.9 | 39.1 ± 26.4 | 49.57 ± 18.2 | 48 |
| | Region B | −501.5 ± 91.3 | −512.6 ± 73.6 | −518.3 ± 150.2 | −678.4 ± 33.8 | −698.4 |
| (b) | Region A | 358.6 ± 110.3 | 169.3 ± 72.4 | 391.3 ± 254.7 | 17.8 ± 16.3 | −94~40 |
| | Region B | −480.2 ± 176.2 | −106.4 ± 45.7 | −175.8 ± 73.5 | −38.1 ± 14.6 | −94~40 |
| (c) | Region A | −389.6 ± 813.2 | 247.4 ± 99.2 | 222.1 ± 95.6 | 31 ± 61 | −100~54 |
| | Region B | −947.1 ± 133.4 | 45.4 ± 149.5 | −72.6 ± 102.4 | −64.6 ± 61.3 | −100~54 |
| (d) | Region A | 968.9 ± 747.5 | 485.6 ± 138.2 | 781.1 ± 477.4 | 40.2 ± 24.3 | −40~91 |
| | Region B | −630.2 ± 332.2 | −67.9 ± 73.6 | −227.8 ± 56.8 | 1.7 ± 54.3 | −40~91 |

The reference value of the data in group a (simulated phantom) is the CT value when there is no metal, and due to the effect of metal artifact, the reference value of the data in groups (b) to (d) can not be accurately obtained, so the CT value of the surrounding artifact-free region was utilized for replacing, which gives an approximate range of the CT value.

From the data in Table 1 above, it can be learned that different correction methods can, to a certain extent, improve the accuracy of the CT values of the images and reduce the unevenness of the CT values. By comparing the statistical results, the method for correcting the metal artifact described in the embodiments of the present disclosure achieves a better correction effect compared to the other methods, and the CT value of the corrected image is closer to the reference CT value.

The embodiments of the present disclosure include but are not limited to the following beneficial effects. First, in the process of determining regions with different densities, segmenting the overall image into a plurality of sub-regions before performing local threshold segmentation can make the final results of high-density regions, medium-density regions and low-density regions more accurate. Second, smoothing the boundary region of the projection map difference between the second image and the template image projection map can effectively avoid the introduction of new artifacts due to the truncation process of the projection value. Third, filtering the metal artifacts of the obtained image can further reduce the errors due to the selection of the parameters of the other steps, etc. Fourth, the iterative correction by updating the corrected image to the second image can gradually remove the artifacts and improve the correction effect of the image.

It should be noted that beneficial effects that may be produced by different embodiments are different, and the beneficial effects that may be produced in different embodiments may be any one or a combination of any of the foregoing, or any other beneficial effect that may be obtained.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about”, “approximate”, or “substantially”. For example, “about”, “approximate”, or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method for correcting a metal artifact, comprising:
obtaining a first image acquired by a first imaging device and a second image acquired by a second imaging device, the second imaging device including a computed tomography (CT) device;
registering the first image and the second image;
determining a template image based on the registered first image and second image;
determining a metal artifact image based on the template image; and
generating a corrected image by correcting, based on the metal artifact image, the second image.

2. The method of claim 1, wherein the first imaging device includes a CT device having a first energy level, the second imaging device includes a CT device having a second energy level, and the first energy level is greater than the second energy level.

3. The method of claim 1, wherein the first imaging device includes a megavoltage CT device and the second imaging device includes a kilovoltage CT device.

4. The method of claim 1, wherein the first image includes a cone-beam CT image, and the second image includes a diagnostic CT image.

5. The method of claim 1, wherein the determining a template image based on the registered first image and second image includes:
determining regions with different densities based on the first image, wherein the regions with different densities include a high-density region, a medium-density region, and a low-density region; and
obtaining the template image by filling the regions with different densities based on CT values of regions in the second image corresponding to the regions with different densities.

6. (canceled)

7. The method of claim 5, wherein the determining regions with different densities based on the first image includes:
determining the high-density region, the medium-density region, and the low-density region by processing the first image using local threshold segmentation.

8. The method of claim 7, wherein the determining the high-density region, the medium-density region, and the low-density region by processing the first image using local threshold segmentation includes:
dividing the first image into a plurality of sub-regions;
determining, based on at least two local thresholds, a high-density sub-region, a medium-density sub-region, and a low-density sub-region of each sub-region among the plurality of sub-regions; and
generating the high-density region, the medium-density region, and the low-density region by combining the high-density sub-regions, the medium-density sub-regions, and the low-density sub-regions of the plurality of sub-regions.

9. The method of claim 8, wherein the dividing the first image into a plurality of sub-regions includes:
dividing the first image into the plurality of sub-regions based on contouring information.

10. The method of claim 5, wherein the determining regions with different densities based on the first image includes
determining the high-density region and the medium-density region by processing the first image using local threshold segmentation;
generating a composite image by fusing the second image and the first image; and
determining the low-density region by processing the composite image using local threshold segmentation.

11. The method of claim 5, wherein the obtaining the template image by filling the regions with different densities based on CT values of regions in the second image corresponding to the regions with different densities includes:
filling the high-density region based on CT values of pixels of a first region in the second image, the first region being a region in the second image corresponding to the high-density region;
filling the medium-density region based on an average of CT values of pixels of a second region in the second image, the second region being a region in the second image corresponding to the medium-density region;
filling the low-density region based on an average of CT values of pixels of a third region in the second image, the third region being a region in the second image corresponding to the low-density region; and
generating the template image based on the filled high-density region, the filled medium-density region, and the filled low-density region.

12. The method of claim 1, wherein the determining a metal artifact image based on the template image includes:
determining a metal region based on the second image;
generating a metal projection map by performing forward projection on the metal region, a non-zero region in the metal projection map being a metal projection region;
generating a second image projection map by performing forward projection on the second image;
generating a template image projection map by performing forward projection on the template image;
determining a projection map difference between the second image projection map and the template image projection map in the metal projection region; and
determining the metal artifact image based on the projection map difference.

13. The method of claim 12, wherein the determining the metal artifact image based on the projection map difference includes:
obtaining a processed projection map difference by smoothing a boundary region in the projection map difference; and
obtaining the metal artifact image by performing a back projection reconstruction based on the processed projection map difference.

14. The method of claim 13, wherein the smoothing a boundary region in the projection map difference includes:
determining an extended distance between an upper boundary and a lower boundary of the boundary region; and
obtaining the processed projection map difference by performing a linear interpolation based on the extended distance between the upper boundary and the lower boundary.

15. The method of claim 14, wherein the determining an extended distance between an upper boundary and a lower boundary of the boundary region includes:
determining the extended distance between the upper boundary and the lower boundary using a machine learning model.

16. The method of claim 1, wherein the generating a corrected image by correcting, based on the metal artifact image, the second image includes:
obtaining a processed metal artifact image by filtering the metal artifact image; and
obtaining the corrected image by correcting, based on the processed metal artifact image, the second image.

17. The method of claim 1, wherein the generating a corrected image by correcting, based on the metal artifact image, the second image includes:
obtaining the corrected image by subtracting the metal artifact image from the second image.

18. The method of claim 1, further comprising:
updating, based on the corrected image, the second image for one or more iterations.

19. The method of claim 18, wherein the updating, based on the metal artifact image, the second image for one or more iterations includes:
updating the template image based on an updated second image;
updating the metal artifact image based on an updated template image;
obtaining an updated corrected image by correcting, based on the updated metal artifact image, the updated second image.

20. (canceled)

21. A system for correcting a metal artifact, comprising:
at least one storage device configured to store computer instructions; and
at least one processor configured to be in communication with the at least one storage device, when executing the computer instructions, the at least one processor being configured to perform operations including:
obtaining a first image acquired by a first imaging device and a second image acquired by a second imaging device, the second imaging device including a computed tomography (CT) device;
registering the first image and the second image;
determining a template image based on the registered first image and second image;
determining a metal artifact image based on the template image; and
generating a corrected image by correcting, based on the metal artifact image, the second image.

22. (canceled)

23. A non-transitory computer-readable storage medium storing computer instructions, wherein when a computer reads the computer instructions in the storage medium, the computer performs a method for correcting a metal artifact, the method including:
obtaining a first image acquired by a first imaging device and a second image acquired by a second imaging device, the second imaging device including a computed tomography (CT) device;
registering the first image and the second image;
determining a template image based on the registered first image and second image;
determining a metal artifact image based on the template image; and
generating a corrected image by correcting, based on the metal artifact image, the second image.
